(19) United States
(12) Patent Application Publication
(10) Pub. No.: US 2024/0252993 A1
(43) Pub. Date: Aug. 1, 2024

(54) PREPARATION SYSTEM OF HYDROSOL SOLUTION

(71) Applicant: JIANGSU AIFOCUS HEALTH TECHNOLOGY CO., LTD., Jingjiang City (CN)

(72) Inventors: Guodong ZHANG, Jingjiang City (CN); Zhongke CHEN, Jingjiang City (CN); Xudong XIA, Jingjiang City (CN); Lei SHU, Jingjiang City (CN); Qing ZHU, Jingjiang City (CN); Bingqing ZHU, Jingjiang City (CN); Hui HUANG, Jingjiang City (CN)

(21) Appl. No.: 18/513,586

(22) Filed: Nov. 19, 2023

Related U.S. Application Data
(63) Continuation of application No. PCT/CN2023/111287, filed on Aug. 4, 2023.

(30) Foreign Application Priority Data
Jan. 28, 2023 (CN) 202310493642.9

(51) Int. Cl. B01F 25/10; B01F 25/313; B01F 33/80

(52) U.S. Cl. CPC B01F 25/10; B01F 25/3131; B01F 33/8361

(57) ABSTRACT

The present disclosure discloses a preparation system of hydrosol solution, which includes a mixing and shearing device, a controller, and a plurality of feeding stations. The plurality of feeding stations are configured to store materials with different material properties, and all of the plurality of feeding stations are connected with the mixing and shearing device and transport the materials with different material properties to the mixing and shearing device. The controller is electrically connected with the plurality of feeding stations and controls material transportation speeds of the plurality of feeding stations. The controller is electrically connected with the mixing and shearing device and controls the operation of the mixing and shearing device, and the mixing and shearing device is configured to simultaneously mix and shear the materials with different material properties to obtain the hydrosol solution.

### TECHNICAL FIELD

The present disclosure relates to the technical field of hydrosol solution processing, and more particularly, to a preparation system of hydrosol solution.

### BACKGROUND ART

As a highly hydrophilic polymer material, water-soluble colloid can dissolve or swell in water to form a relatively viscous aqueous solution or dispersion system, this aqueous solution and dispersion system are commonly referred to as a polymer aqueous solution or hydrosol solution. The hydrophilic groups in the water-soluble colloid not only make them water soluble, but also have chemical functions, as well as various physical functions such as dispersion, flocculation, viscosification, drag reduction, adhesion, film formation, gelation, chelation. Therefore, the water-soluble colloid has wide application in the daily chemicals, food, and pharmaceutical industries.

Due to the complexity of the structure of polymer compounds such as high molecular weight and polydispersity, the dissolution thereof is much more complex than that of small-molecule substances. The size difference between polymers and solvent molecules is significant, and the difference between the molecular motion speed of the polymers and the solvent molecules is also significant. The solvent molecules can penetrate into the polymers relatively quickly, while the diffusion of the polymers into the solvents is very slow. In this way, the dissolution process of the polymers goes through two stages. Firstly, the solvent molecules penetrate into the interior of the polymers to cause the volume of the polymers to expand, which is referred to as “swelling”. Then, the polymers are uniformly dispersed in the solvent to form a completely dissolved homogeneous system with molecules dispersed. The entire dissolution process takes a long time and usually requires stirring, shear homogenization, and other conditions. Meanwhile, in order to accelerate the dissolution of certain polymer colloid, it is necessary to carry out under higher temperature conditions.

The water-soluble colloid has widely application in food, is an indispensable food ingredient in some types of food, and plays an important role. For example, for gel jelly products, soft sweets products, soft capsules and other products in the food industry, the water-soluble colloid needs to be used and formulated into the hydrosol solution to obtain the final products.

The existing hydrosol solution preparation process, such as the process for preparing the hydrosol solution of gelatinized candies, is as follows: sugar melting: adding white granulated sugar, glucose syrup and water into a sugar melting tank for dilution; colloidal dissolution: transporting the diluted solution to a colloid-dissolving tank and adding vegetable gelatin and a large amount of water for high-temperature colloidal dissolution; sugar boiling: after the colloidal dissolution, transporting the solution to a sugar boiling tank for boiling, and filtering out the water to obtain syrup; temporary storage: transporting the obtained syrup to a temporary storage tank for temporary storage; and sugar solution preparation: transporting the sugar solution in the temporary storage tank to a function mixing tank, and adding the required functional ingredients to obtain the required hydrosol solution of gelatinized candies.

The above hydrosol solution process requires multiple steps of sugar melting, colloidal dissolution, sugar boiling, as well as function stirring and mixing; the preparation process requires multiple people to follow the production process step by step; the workload of the operators is high; and the production process is cumbersome and poor in continuity. The entire preparation process takes 4-5 hours, and the entire process takes a long time, resulting in high production costs.

### SUMMARY OF THE INVENTION

For the defects in the prior art, the present disclosure provides a preparation system of hydrosol solution. The system can reduce the workload of operators; the production process is simple; the continuity is high; and the time consumed by the entire process is reduced.

The present disclosure is implemented through the following technical solutions:

A preparation system of hydrosol solution is provided, which includes a mixing and shearing device, a controller, and a plurality of feeding stations. The plurality of feeding stations are configured to store materials with different material properties, and all of the plurality of feeding stations are connected with the mixing and shearing device and transport the materials with different material properties to the mixing and shearing device. The controller is electrically connected with the plurality of feeding stations and controls material transportation speeds of the plurality of feeding stations. The controller is electrically connected with the mixing and shearing device and controls the operation of the mixing and shearing device, and the mixing and shearing device is configured to simultaneously mix and shear the materials with different material properties to obtain the hydrosol solution.

Further, the mixing and shearing device comprises a processing pipeline, a first screw, and a drive motor. The feeding stations are in communication with the processing pipeline to transport materials with different material properties into the processing pipeline. The first screw is arranged inside the processing pipeline. The drive motor is electrically connected with the controller to drive the first screw to simultaneously mix and shear all the materials in the processing pipeline to obtain the hydrosol solution. The first screw discharges the obtained hydrosol solution from a discharge port of the processing pipeline.

Further, the plurality of feeding stations include a first feeding unit for storing solid phase materials and a second feeding unit for storing aqueous phase materials, and both the first feeding unit and the second feeding unit are in communication with the processing pipeline through a pipeline.

Further, the plurality of feeding stations further include a third feeding unit for storing aqueous phase functional materials and a fourth feeding unit for storing oil phase functional materials, and both the third feeding unit and the fourth feeding unit are in communication with the processing pipeline through the pipeline.

Further, a first feeding port and a second feeding port are provided in one end of the processing pipeline close to the drive motor, a third feeding port and a fourth feeding port are provided in one end of the processing pipeline close to the discharge port. The first feeding unit is connected to the first feeding port, the second feeding unit is connected to the second feeding port, the third feeding unit is connected to the third feeding port, and the fourth feeding unit is connected to the fourth feeding port.

Further, the first feeding unit includes a hopper for storing the solid phase materials, a second propulsion screw, a solid material pipeline, and a servo motor. One side of the solid material pipeline is connected with the hopper, and the other side is connected with the first feeding port through the pipeline. The second propulsion screw is arranged in the solid material pipeline, and the servo motor is electrically connected with the controller to drive the second propulsion screw to mix and shear the solid materials and send them to the processing pipeline.

Further, the second feeding unit includes at least one second batching tank for holding the aqueous phase materials and a second metering pump. The second batching tank is connected to the second feeding port through the pipeline, and the second metering pump is arranged on the pipeline to control a flow rate of the aqueous phase materials entering the processing pipeline.

Further, the third feeding unit includes at least one third batching tank for holding the aqueous phase functional materials and a third metering pump. The third batching tank is connected to the third feeding port through the pipeline, and the third metering pump is arranged on the pipeline to control a flow rate of the aqueous phase functional materials entering the processing pipeline.

Further, the fourth feeding unit includes at least one fourth batching tank for holding the oil phase functional materials and a fourth metering pump. The fourth batching tank is connected to the fourth feeding port through the pipeline, and the fourth metering pump is arranged on the pipeline to control a flow rate of the oil phase functional materials entering the processing pipeline.

Further, the first screw includes a plurality of sets of propulsion sections and shearing sections, and the propulsion sections and the shearing sections are arranged at intervals from each other.

Further, the first feeding port, the second feeding port, the third feeding port, and the fourth feeding port all correspond to positions of the propulsion sections in the processing pipeline.

Further, the first feeding port and the second feeding port correspond to the same propulsion section in the processing pipeline, and the third feeding port and the fourth feeding port correspond to the same propulsion section in the processing pipeline.

Further, a portion of the first screw located between the second feeding port and the third feeding port is provided with at least one set of shearing sections.

Further, a portion of the first screw located between the third feeding port and the discharge port is provided with at least one set of shearing sections.

Further, the propulsion section is composed of a plurality of sets of propulsion thread modules, and the shearing section is composed of a plurality of sets of shearing thread modules. A thread pitch d1 of the propulsion thread module of the propulsion section is 36-112 mm, and a thread pitch d2 of the shearing thread module of the shearing section is 22-96 mm.

Further, the plurality of feeding stations further include a fifth feeding unit for storing other ingredients. The fifth feeding unit includes at least one fifth batching tank for holding the other ingredients and a fifth metering pump. The fifth batching tank is connected to a fifth feeding port in the processing pipeline through the pipeline. The fifth feeding port and the third feeding port correspond to the same propulsion section in the processing pipeline. The fifth metering pump is arranged on the pipeline to control a flow rate of the other ingredients entering the processing pipeline.

Compared to the prior art, the advantages of the present disclosure are as follows:

1. The system and preparation method can be applied to the preparation process of hydrosol solution in daily chemicals, food and drugs, and can simultaneously introduce various functional ingredients and auxiliary materials online, especially, it has more advantages in the preparation of relatively viscous water-soluble systems such as gel jelly solution, soft capsule rubber solution, soft sweets syrup.

2. The process and system also have unique advantages in the aspect of heat-sensitive functional materials. The first feeding unit for storing the solid phase materials and the second feeding unit for storing the aqueous materials are connected to one side of the processing pipeline close to the drive motor, the materials entering the online material mixing and shearing device are fully dispersed, dissolved, and sheared, the third feeding units and fourth feeding units for storing the functional materials and the fifth feeding unit for storing other ingredients are connected near the outlet end of the processing pipeline, which reduces the time for heating, mixing and shearing of the functional materials, greatly improves the stability of functional ingredients, reduces the loss of nutrients, resulting in higher functional content and better quality of the obtained hydrosol solution.

3. Compared with the traditional hydrosol solution preparation process, this process changes the process of gradually adding, mixing, and boiling, uses a material mixing and shearing device and a quantitative feeding system to cascade the hydrosol solution preparation process, and digitally and automatically adjusts the discharging rate according to the proportion of materials in the formula, which simplifies the hydrosol solution preparation process, makes the data of the hydrosol solution preparation process clearer and the adjustment method more controllable, and saves time and labor costs. Compared with batch production, this process can achieve continuous production of hydrosol solution preparation, which lowers production costs, and improves labor efficiency.

4. The system and process are short in hydrosol solution preparation time. From the feeding of each material to the final hydrosol solution preparation, it only takes the time to pass through the online material mixing and shearing device, which reduces the time consumed by the entire process, and the preparation time of the hydrosol solution does not exceed 3 min, greatly improving production efficiency.

5. The workload of operators is reduced, the production process is simple, the continuity is high, the occupation of factory space is reduced, and the economic benefits are improved.

### BRIEF DESCRIPTION OF THE DRAWINGS

FIG. 1 is a schematic structural diagram of a preparation system of hydrosol solution according to an example of the present disclosure;

FIG. 2 is a schematic structural diagram of a heat insulation pipeline;

FIG. 3 is a schematic structural diagram of a first screw;

FIG. 4 is a control block diagram of a preparation system of hydrosol solution; and

FIG. 5 is a flowchart of a preparation method of hydrosol solution.

100. Mixing and shearing device; 101. processing pipeline; 110. discharge port; 111. first feeding port; 112. second feeding port; 113. third feeding port; 114. fourth feeding port; 115. fifth feeding port; 102. first screw; 121. propulsion section; 122. shearing section; 123. propulsion thread module; 124. shearing thread module; 103. drive motor; 104. electromagnetic infrared heater; 105. heat insulation sleeve; 106. pressure sensor; 107. first temperature sensor; 108. second temperature sensor; 109. frequency converter; 200. controller; 300. feeding station; 1. first feeding unit; 10. hopper; 11. second propulsion screw; 12. solid material pipeline; 13. servo motor; 2. second feeding unit; 20. second batching tank; 21. second metering pump; 3. third feeding unit; 30. third batching tank; 31. third metering pump; 4. fourth feeding unit; 40. fourth batching tank; 41. fourth metering pump; 5. fifth feeding unit; 50. fifth batching tank; 51. fifth metering pump; 6. stirring apparatus; 60. stirring motor; 61. stirring rod; 7. tank sleeve; 70. third temperature sensor; 400. pipeline; 401. pipe sleeve; 402. heat insulation chamber; 403. hot water tank; 404. hot water pump; 500. bottom plate; 501. base; 502. installation plate; 503. first support frame; 504. second support frame; 505. support plate; and 600. man-machine interface.

### DETAILED DESCRIPTION OF THE INVENTION

The following provides a further non-restrictive detailed description of the inventive technical solution in conjunction with preferred examples and accompanying drawings. In the description of the present disclosure, it should be understood that the orientation or positional relationship indicated by the terms “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial” and “circumferential” is based on the orientation or positional relationship shown in the accompanying drawings. In addition, the terms “first” and “second” are only used for the purpose of description and cannot be understood as indicating or implying relative importance or implying the quantity of technical features indicated. Therefore, features defined as “first” and “second” can explicitly or implicitly include at least one of these features. In the description of the present disclosure, “a plurality of” means at least two, such as two, three, etc., unless otherwise specifically defined. The examples described below with reference to the accompanying drawings are exemplary and intended to explain the present disclosure, but cannot be understood as limitations on the present disclosure.

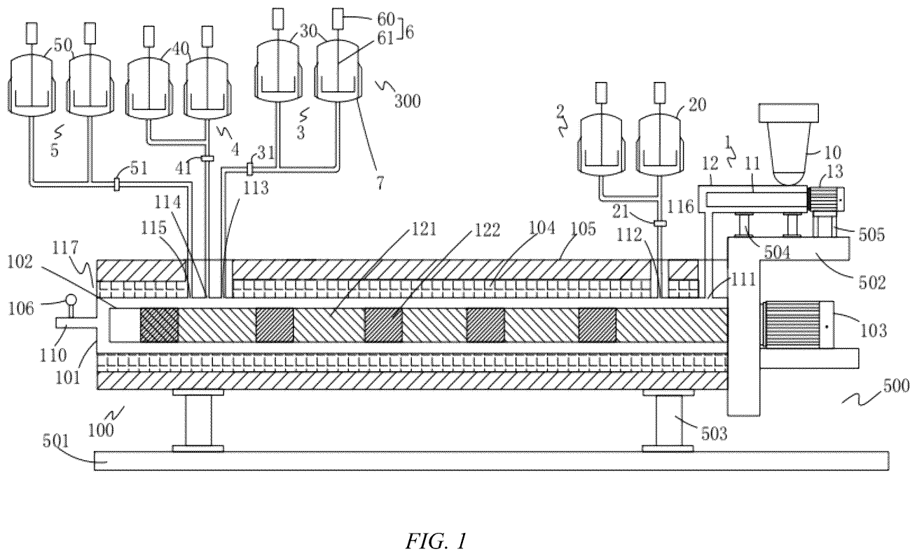

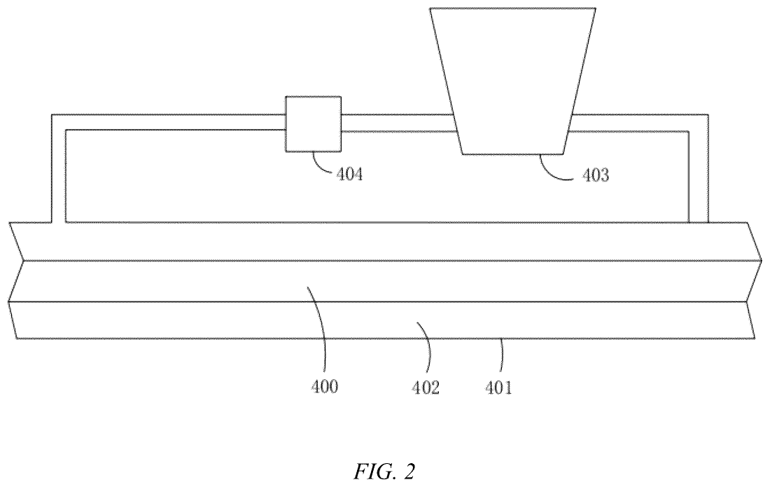

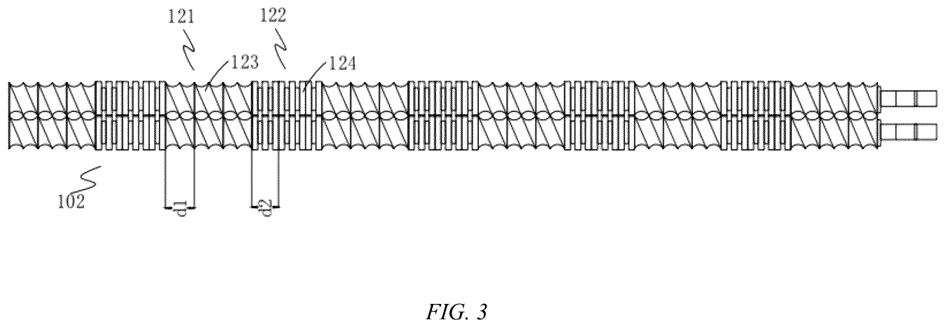

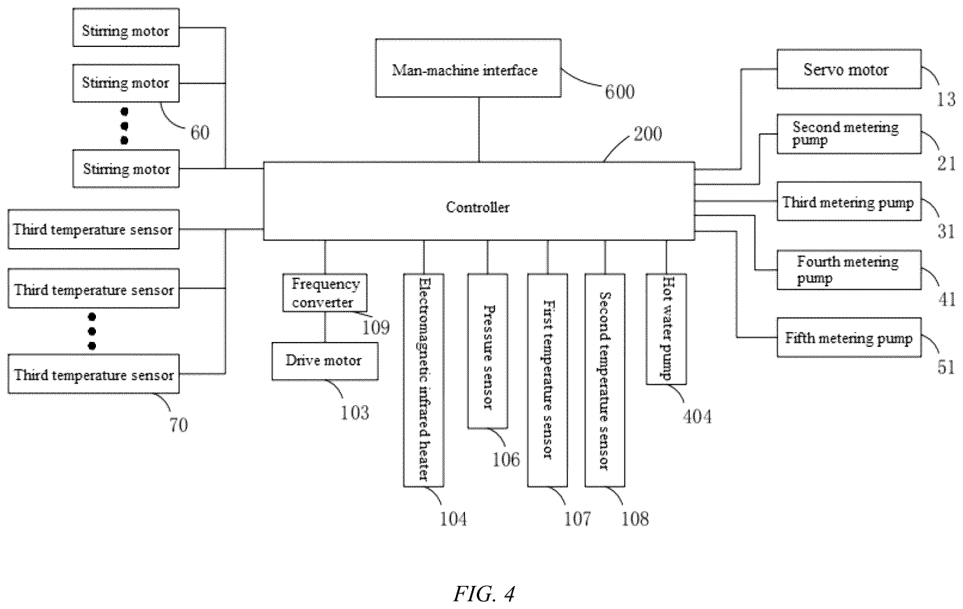

As shown in FIGS. 1-4, an example of the present disclosure provides a preparation system of hydrosol solution, which includes: a mixing and shearing device 100, a controller 200, a plurality of feeding stations 300 and a man-machine interface 600. The feeding station 300 is connected with the mixing and shearing device 100 through a pipeline 400 and transports materials with different material properties to the mixing and shearing device 100. The controller 200 is electrically connected with the plurality of feeding stations 300 and controls the material transportation speed of each feeding station 300. The controller 200 is electrically connected with the mixing and shearing device 100 and controls the operation of the mixing and shearing device 100. The mixing and shearing device 100 is configured to simultaneously mix and shear materials with different material properties to obtain the hydrosol solution. After processing, the hydrosol solution is discharged from the mixing and shearing device 100, and the man-machine interface 600 is electrically connected with the controller 200 to issue work instructions and display various system parameters.

The mixing and shearing device 100 includes a processing pipeline 101, a first screw 102, a drive motor 103, and an electromagnetic infrared heater 104. The feeding station 300 is in communication with the processing pipeline 101 to transport materials with different material properties to the processing pipeline 101. The electromagnetic infrared heater 104 is arranged at an outer side of the processing pipeline 101 and is electrically connected with the controller 200. A heat insulation sleeve 105 is arranged at an outer side of the electromagnetic infrared heater 104. The first screw 102 is arranged inside the processing pipeline 101. The drive motor 103 is fixedly connected with the first screw 102, and the drive motor 103 is electrically connected with the controller 200 to drive the first screw 102 to simultaneously mix and shear all the materials in the processing pipeline 101 to obtain the hydrosol solution. The first screw 102 discharges the obtained hydrosol solution from a discharge port 110 of the processing pipeline 101.

The mixing and shearing device 100 further includes a bottom plate 500. The processing pipeline 101 and the drive motor 103 are fixedly arranged on the bottom plate 500.

The bottom plate 500 includes a base 501, as well as an installation plate 502 and a first support frame 503 fixed on the base 501. The processing pipeline 101 is fixed above the first support frame 503, the drive motor 103 is fixed on the installation plate 502, and a motor shaft (not shown in the figure) of the drive motor 103 passes through the first support frame 503 to drive the first screw 102 to rotate.

A second support frame 504 and a support plate 505 are further fixed on the installation plate 502, the second support frame 504 is fixedly connected with a solid material pipeline 12, and the support plate 505 is fixedly connected with a servo motor 13. A second feeding unit 2, a third feeding unit 3, a fourth feeding unit 4, and a fifth feeding unit 5 are all fixed above the processing pipeline 101 through installation racks (not shown in the figure).

Specifically, the controller 200 controls the operation of the drive motor 103 through a frequency converter 109.

A pressure sensor 106 is arranged at the discharge port 110. The pressure sensor 106 is electrically connected with the controller 200. When the pressure sensor 106 detects that a pressure value at the discharge port 110 is higher than a set threshold, a signal is fed back to the controller 200, the controller 200 controls the drive motor 103 to reduce the rotating speed; otherwise, increases the rotating speed of the drive motor 103.

A first temperature sensor 107 is arranged inside the processing pipeline 101 to monitor the temperature of the materials inside the processing pipeline 101. A second temperature sensor 108 is arranged inside the heat insulation sleeve 105, and both the first temperature sensor 107 and the second temperature sensor 108 are connected with the controller 200. When the first temperature sensor 107/the second temperature sensor 108 is lower than the preset temperature, the controller 200 controls the electromagnetic infrared heater 104 to work; otherwise, the electromagnetic infrared heater 104 is turned off to maintain the temperature inside the processing pipeline 101 to be within the temperature range required for the processing of the hydrosol solution. In addition, the electromagnetic infrared heater 104 can also be controlled by the controller 200 to continuously heat the processing pipeline 101. The first temperature sensor 107 and the second temperature sensor 108 respectively monitor whether the temperature inside the processing pipeline 101 and the heat insulation sleeve 105 meets the working requirements.

A plurality of feeding ports are provided in the processing pipeline 101, and the number of the feeding ports is consistent with the number of the feeding stations 300, ensuring that each of the feeding stations 300 is connected with one of the feeding ports. In this example, five feeding ports are provided, namely a first feeding port 111, a second feeding port 112, a third feeding port 113, a fourth feeding port 114, and a fifth feeding port 115. The first feeding port 111 and the second feeding port 112 are adjacently provided in one end of the processing pipeline 101 close to the drive motor 103, and the third feeding port 113, the fourth feeding port 114 and the fifth feeding port 115 are adjacently provided in one end of the processing pipeline 101 close to the discharge port 110 (i.e., the end of the processing pipeline 101 away from the drive motor 103). Due to the large proportion of the solid phase materials and the aqueous phase materials in the materials required for the hydrosol solution, the first feeding port 111 and the second feeding port 112 respectively corresponding to a first feeding unit 1 for storing the solid phase materials and the second feeding unit 2 for storing the aqueous phase materials are adjacently provided in the end of the processing pipeline 101 close to the drive motor 103, in order to ensure that the solid phase materials and the aqueous phase materials have sufficient time to be sheared in the processing pipeline 101, achieving the purpose of sufficient shearing. After sufficient shearing, the solid phase materials and the aqueous phase materials are sheared and mixed with small proportions of aqueous phase functional materials, oil phase functional materials, and other ingredients. The device design is scientific and reasonable, and unnecessary energy consumption is reduced.

In this example, a twin-screw mixing and shearing device is used, two identical first screws 102 are used to work together to mix and shear the materials in the processing pipeline 101. A diameter of the first screw 102 is 75 mm, and the first screw 102 includes a plurality of sets of propulsion sections 121 and shearing sections 122. The propulsion sections 121 and the shearing sections 122 are arranged at intervals from each other. The propulsion section 121 is composed of a plurality of sets of propulsion thread modules 123, and the shearing section 122 is composed of a plurality of sets of shearing thread modules 124. The first feeding port 111, the second feeding port 112, the third feeding port 113, the fourth feeding port 114, and the fifth feeding port 115 all correspond to the positions of the propulsion sections 121 in the processing pipeline 101, and the first feeding port 111 and the second feeding port 112 correspond to the same propulsion section 121 in the processing pipeline 101, while the third feeding port 113, the fourth feeding port 114, and the fifth feeding port 115 correspond to the same propulsion section 121 in the processing pipeline 101. Further, a portion of the first screw 102 located between the second feeding port 112 (the first feeding port 111) and the third feeding port 113 (the fourth feeding port 114/the fifth feeding port 115) is provided with at least one set of shearing sections 122, and a portion of the first screw 102 located between the third feeding port 113 (the fourth feeding port 114/the fifth feeding port 115) and the discharge port 110 is provided with at least one set of shearing sections 122. That is, the materials entering from each of the feeding ports are preliminarily mixed through the propulsion section 121 and pushed to the shearing section 122, and different materials are fully sheared and mixed by the shearing section 122. The first screw is arranged at intervals through the propulsion section 121 and the shearing section 122, and the propulsion section 121 can quickly mix different materials and shear them through the shearing section 122. A thread pitch of the propulsion thread module 123 of the propulsion section 121 is large, and a distance pushed by the propulsion section per unit time is long, which improves the processing efficiency of the materials.

A thread pitch d1 of the propulsion thread module 123 of the propulsion section 121 is 36-112 mm, and a thread pitch d2 of the shearing thread module 124 of the shearing section 122 is 22-96 mm. In this example, the thread pitch d1 of the propulsion thread module 123 of the propulsion section 121 is specifically 72 mm, a cumulative total length of the propulsion section 121 is 216 mm; the thread pitch d2 of the shearing thread module 124 of the shearing section 122 is specifically 56 mm, and a cumulative total length of the shearing section is 168 mm.

In this example, the controller 200 selects PLC S7-1200.

The feeding station 300 includes the first feeding unit 1 for storing the solid phase materials, the second feeding unit 2 for storing the aqueous phase materials, the third feeding unit 3 for storing the aqueous phase functional materials, the fourth feeding unit 4 for storing the oil phase functional materials, and the fifth feeding unit 5 for storing the other ingredients. The first feeding unit 1, the second feeding unit 2, the third feeding unit 3, the fourth feeding unit 4, and the fifth feeding unit 5 are all in communication with the processing pipeline 101 through the pipeline 400. Specifically, the first feeding unit 1 is connected to the first feeding port 111 in the processing pipeline 101, the second feeding unit 2 is connected to the second feeding port 112 in the processing pipeline 101, the third feeding unit 3 is connected to the third feeding port 113 in the processing pipeline 101, the fourth feeding unit 4 is connected to the fourth feeding port 114 in the processing pipeline 101, and the fifth feeding unit 5 is connected to the fifth feeding port 115 in the processing pipeline 101.

The first feeding unit 1 includes a hopper 10 for storing the solid phase materials, a second propulsion screw 11, the solid material pipeline 12, and the servo motor 13. One side of the solid material pipeline 12 is connected with the hopper 10, and the other side is connected with the first feeding port 111 through the pipeline 400. The second propulsion screw 11 is arranged in the solid material pipeline 12, and the servo motor 13 is electrically connected with the controller 200 to drive the second propulsion screw 11 to push the solid materials and send them to the processing pipeline 101.

The second feeding unit 2 includes at least one second batching tank 20 for holding the aqueous phase materials and a second metering pump 21. The second batching tank 20 is connected to the second feeding port 112 through the pipeline 400, and the second metering pump 21 is arranged on the pipeline 400 to control a flow rate of the aqueous phase materials entering the processing pipeline 101.

The third feeding unit 3 includes at least one third batching tank 30 for holding the aqueous phase functional materials and a third metering pump 31. The third batching tank 30 is connected to the third feeding port 113 through the pipeline 400, and the third metering pump 31 is arranged on the pipeline 400 to control a flow rate of the aqueous phase functional materials entering the processing pipeline 101.

The fourth feeding unit 4 includes at least one fourth batching tank 40 for holding the oil phase functional materials and a fourth metering pump 41. The fourth batching tank 40 is connected to the fourth feeding port 114 through the pipeline 400, and the fourth metering pump 41 is arranged on the pipeline 400 to control a flow rate of the oil phase functional materials entering the processing pipeline 101.

The fifth feeding unit 5 includes at least one fifth batching tank 50 for holding the other ingredients and a fifth metering pump 51. The fifth batching tank 50 is connected to the fifth feeding port 115 in the processing pipeline 101 through the pipeline 400, and the fifth metering pump 51 is arranged on the pipeline 400 to control a flow rate of the other ingredients entering the processing pipeline 101.

The second batching tank 20, the third batching tank 30, the fourth batching tank 40, and the fifth batching tank 50 are all provided with a stirring apparatus 6. The stirring apparatus 6 includes a stirring motor 60 electrically connected with the controller 200 and a stirring rod 61 connected with the stirring motor 60. The stirring motor 60 drives the stirring rod 61 to mix different materials in the batching tanks and preliminarily mix the materials evenly. In addition, the second batching tank 20, the third batching tank 30, the fourth batching tank 40, and the fifth batching tank 50 all have heating functions.

Each of outer sides of the second batching tank 20, the third batching tank 30, the fourth batching tank 40, and the fifth batching tank 50 is provided with a tank sleeve 7. Each of the tank sleeves 7 is provided with a third temperature sensor 70, and the third temperature sensor 70 is electrically connected with the controller 200 to monitor the temperature of each of the batching tanks.

A pipe sleeve 401 is arranged at an outer side of the pipeline 400, and a heat insulation chamber 402 is formed between the pipe sleeve 401 and the pipeline 400. A hot water tank 403 and a hot water pump 404 are provided at an outer side of the pipe sleeve 401, and the hot water tank 403, the hot water pump 404, and the heat insulation chamber 402 are in communication with each other. The hot water tank 403 has a self-heating function, and the hot water pump 404 is connected with the controller 200 to drive the circulation of hot water in the heat insulation chamber 402 and the hot water tank 403, so as to achieve the purpose of insulating the pipeline 400. The numbers of the hot water pumps 404 and the hot water tank 403 can be independently set according to the temperature requirements of different pipelines 400.

The man-machine interface 600 can display temperature values detected by the temperature sensors, pressure values detected by the pressure sensor 106, and rotating speeds of the motors. The power of the hot water pump and the rotating speeds of the motors can also be set. The process digitally and automatically adjusts the discharging rate according to the proportion of materials in the formula, which simplifies the hydrosol solution preparation process, makes the data of the hydrosol solution preparation process clearer and the adjustment method more controllable, and saves time and labor costs.

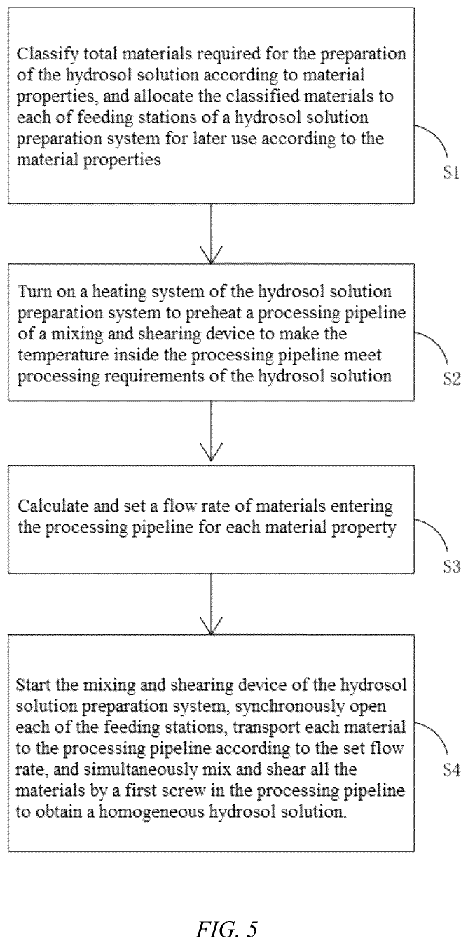

As shown in FIG. 5, an example of the present disclosure provides a preparation method of hydrosol solution, which includes the following steps:
step S1: total materials required for the preparation of the hydrosol solution are classified according to material properties, and the classified materials are allocated to each of feeding stations 300 of a hydrosol solution preparation system for later use according to the material properties.

Step S1 specifically includes the following steps:
step S10: the total materials required for the preparation of the hydrosol solution are classified into solid phase materials, aqueous phase materials, aqueous phase functional materials, oil phase functional materials, and other ingredients according to the material properties.
step S11: the solid phase materials are allocated to a first feeding unit 1, the aqueous phase materials are allocated to a second feeding unit 2, the aqueous phase functional materials are allocated to a third feeding unit 3, the oil phase functional materials are allocated to a fourth feeding unit 4, and the other ingredients are allocated to a fifth feeding unit 5 simultaneously; and
step S12: temperature control is performed on each of the feeding units according to the material properties of the materials for later use.

Step S2: A heating system of the hydrosol solution preparation system is turned on to preheat a processing pipeline 101 of a mixing and shearing device 100 to make the temperature inside the processing pipeline 101 meet processing requirements of the hydrosol solution.

Specifically, an electromagnetic infrared heater 104 is turned on to preheat the processing pipeline 101 of the mixing and shearing device 100; whether the temperature inside the processing pipeline 101 meets the processing requirements of the hydrosol solution is determined in real time by a first temperature sensor 107; the processing pipeline 101 of the mixing and shearing device 100 is continuously heated by the electromagnetic infrared heater 104 in a case that the first temperature sensor 107 detects that the temperature value is lower than a preset minimum value, and heating is stopped in a case that the first temperature sensor 107 detects that the temperature value is higher than the preset maximum value; and the temperature inside the processing pipeline 101 is controlled to be within a temperature range required for the processing of the hydrosol solution.

Step S3: A flow rate of materials entering the processing pipeline 101 is calculated and set for each material property.

Step S3 specifically includes the following steps:
step S30: the flow rate of materials entering the processing pipeline 101 is calculated for each material property.

Specifically, a discharging flow rate of a discharge port 110 of the processing pipeline 101 is defined as Vₒᵤₜ, and the range of Vₒᵤₜ is 50-300 kg/h.

The flow rate of various materials entering the processing pipeline 101 meets the following conditions:

$${V}_{a} = {V}_{o u t} \times a ; \\ {V}_{b} = {V}_{o u t} \times b ; \\ {V}_{c} = {V}_{o u t} \times c ; \\ {V}_{d} = {V}_{o u t} \times d ; and$$

$${V}_{e} = {V}_{o u t} \times e ;$$

where Vₐ, V_{b}, V_{c}, V_{d}, and Vₑ are respectively the flow rates of the solid phase materials, the aqueous phase materials, the aqueous phase functional materials, the oil phase functional materials, and the other ingredients entering the processing pipeline 101; and a, b, c, d, and e are respectively mass proportions of the solid phase materials, the aqueous phase materials, the aqueous phase functional materials, the oil phase functional materials, and the other ingredients in the total materials.

Step S31: The calculated material flow rate values for each material property are allocated into each of the feeding stations 300.

By controlling the flow rate of various materials, the control of the proportion of various materials required for the hydrosol solution is achieved. Compared to the traditional method of controlling the proportion of materials by manual weighing, this method is more efficient.

Step S4: The mixing and shearing device 100 of the hydrosol solution preparation system is started, each of the feeding stations 300 is opened, each material is transported to the processing pipeline 101 according to the set flow rate, and all the materials are simultaneously mixed and sheared by a first screw 102 in the processing pipeline 101 to obtain a homogeneous hydrosol solution.

Step S4 specifically includes the following steps:
step S40: the mixing and shearing device 100 of the hydrosol solution preparation system is started, and each of the feeding stations 300 is opened synchronously;
step S41: the solid phase materials and the aqueous phase materials are enabled to enter the processing pipeline 101 from an upstream end 116 of the processing pipeline 101, and the solid phase materials and the aqueous phase materials are preliminarily sheared and mixed under the action of the first screw 102 and then transported to a downstream end 117 of the processing pipeline 101;
step S42: the aqueous phase functional materials, the oil phase functional materials, and the other ingredients are enabled to enter the processing pipeline 101 from the downstream end 117 of the processing pipeline 101, preliminarily mixed with the mixture of the solid phase materials and the aqueous phase materials at the upstream end 116, and further transported towards the discharge port 110;
step S43: the mixture of the aqueous phase functional materials, the oil phase functional materials, and the other ingredients are sheared and mixed with the solid phase materials and the aqueous phase materials again, and then discharged from the processing pipeline 101;
step S44: the solid phase materials, the aqueous phase materials, the aqueous phase functional materials, the oil phase functional materials, and the other ingredients that are not fully and evenly mixed in the processing pipeline 101 in an early working stage of the mixing and shearing device 100 are abandoned; and
step S45: the homogeneous hydrosol solution is obtained at the discharge port 110 of the processing pipeline 101.

### Example 1

A preparation method of soft sweets (pectin) hydrosol solution is provided, which includes the following steps:
step S1: total materials required for the preparation of the soft sweets hydrosol solution are classified according to material properties, and the classified materials are allocated to each of feeding stations 300 of a hydrosol solution preparation system for later use according to the material properties.

Step S1 specifically includes the following steps:
step S10: the total materials required for the preparation of the soft sweets hydrosol solution are classified into solid phase materials, aqueous phase materials, aqueous phase functional materials, oil phase functional materials, and other ingredients according to the material properties. The specific classification is shown in Table 1.

TABLE 1
Classification table of total materials required
for the soft sweets (pectin) hydrosol solution

| | Proportion | | Proportion |
|---|---|---|---|
| | in the total | | in the total |
| Mixture name | materials (%) | Material name | materials (%) |
| Solid phase | 36.486 | White granulated | 34.171 |
| materials | | sugar powder | |
| | | Pectin | 2.315 |
| Aqueous phase | 54.283 | Glucose syrup | 35.935 |
| materials | | Purified water | 18.018 |
| | | Sodium citrate | 0.330 |
| Oil phase | 0.417 | Vitamin E oil | 0.402 |
| functional | | Acetate vitamin | 0.015 |
| materials | | A Oil | |
| Aqueous phase | 6.831 | Vitamin C | 0.556 |
| functional | | Vitamin D3 | 0.056 |
| materials | | (powder) | |
| | | Calcium | 0.590 |
| | | pantothenate | |
| | | Biotin | 0.076 |
| | | Sodium citrate | 0.167 |
| | | Glucose syrup | 4.274 |
| | | Purified water | 1.112 |
| Other | 1.983 | DL-malic acid | 0.526 |
| ingredients | | Anhydrous | 0.240 |
| | | citric acid | |
| | | Purified water | 0.767 |
| | | Peach essence | 0.397 |
| | | Black carrot | 0.053 |
| | | concentrated juice | |

Step S11: The solid phase materials are allocated to a first feeding unit 1, the aqueous phase materials are allocated to a second feeding unit 2, the aqueous phase functional materials are allocated to a third feeding unit 3, the oil phase functional materials are allocated to a fourth feeding unit 4, and the other ingredients are allocated to a fifth feeding unit 5 simultaneously.

Step S12: Temperature control is performed on each of the feeding units according to the material properties of the materials for later use.

The temperature of various materials in the field of soft sweets processing belongs to prior art, and there is no specific limit here. Suitable temperature will be determined based on processing needs.

Step S2: A heating system of the hydrosol solution preparation system is turned on to preheat a processing pipeline 101 of a mixing and shearing device 100 to make the temperature inside the processing pipeline 101 meet processing requirements of the hydrosol solution.

Specifically, an electromagnetic infrared heater 104 is turned on to preheat the processing pipeline 101 of the mixing and shearing device 100; whether the temperature inside the processing pipeline 101 meets the processing requirements of the hydrosol solution is determined in real time by a first temperature sensor 107; the processing pipeline 101 of the mixing and shearing device 100 is continuously heated by the electromagnetic infrared heater 104 in a case that the first temperature sensor 107 detects that the temperature value is lower than a preset minimum value, and heating is stopped in a case that the first temperature sensor 107 detects that the temperature value is higher than the preset maximum value; and the temperature inside the processing pipeline 101 is controlled to be within a temperature range required for the processing of the hydrosol solution.

Step S3: A flow rate of materials entering the processing pipeline 101 is calculated and set for each material property.

Step S3 specifically includes the following steps:
step S30: the flow rate of materials entering the processing pipeline 101 is calculated for each material property.

Specifically, a discharging flow rate of a discharge port 110 of the processing pipeline 101 is defined as Vₒᵤₜ, and Vₒᵤₜ is 200 kg/h.

The flow rate of various materials in the total materials required for the soft sweets (pectin) hydrosol solution entering the processing pipeline 101 meets the following conditions as shown in Table 2 below.

TABLE 2
Flow rate of various materials in the total materials
required for the soft sweets (pectin) hydrosol solution

| | Mass proportion | | |
|---|---|---|---|
| | in the total | Flow rate | |
| Mixture name | materials (%) | (kg/h) | Meeting conditions |
| Solid phase | 36.486 | 72.972 | Vₐ = 200 × 36.486% |
| materials | | | |
| Aqueous phase | 54.283 | 108.566 | V_{b} = 200 × 54.283% |
| materials | | | |
| Aqueous phase | 0.417 | 0.834 | V_{c} = 200 × 0.417% |
| functional | | | |
| materials | | | |
| Oil phase | 6.831 | 13.662 | V_{d} = 200 × 6.831% |
| functional | | | |
| materials | | | |
| Other | 1.983 | 3.964 | Vₑ = 200 × 1.982% |
| ingredients | | | |

Step S31: The calculated material flow rate values for each material property are allocated into each of the feeding stations 300.

Step S4: The mixing and shearing device 100 of the hydrosol solution preparation system is started, each of the feeding stations 300 is opened, each material is transported to the processing pipeline 101 according to the set flow rate, and all the materials are simultaneously mixed and sheared by a first screw 102 in the processing pipeline 101 to obtain a homogeneous hydrosol solution.

Step S4 specifically includes the following steps:
step S40: the mixing and shearing device 100 of the hydrosol solution preparation system is started, and each of the feeding stations 300 is opened synchronously;
step S41: the solid phase materials and the aqueous phase materials are enabled to enter the processing pipeline 101 from an upstream end 116 of the processing pipeline 101, and the solid phase materials and the aqueous phase materials are preliminarily sheared and mixed under the action of the first screw 102 and then transported to a downstream end 117 of the processing pipeline 101;
step S42: the aqueous phase functional materials, the oil phase functional materials, and the other ingredients are enabled to enter the processing pipeline 101 from the downstream end 117 of the processing pipeline 101, preliminarily mixed with the mixture of the solid phase materials and the aqueous phase materials at the upstream end 116, and further transported towards the discharge port 110;
step S43: the mixture of the aqueous phase functional materials, the oil phase functional materials, and the other ingredients are sheared and mixed with the solid phase materials and the aqueous phase materials again, and then discharged from the processing pipeline 101;
step S44: the solid phase materials, the aqueous phase materials, the aqueous phase functional materials, the oil phase functional materials, and the other ingredients that are not fully and evenly mixed in the processing pipeline 101 in an early working stage of the mixing and shearing device 100 are abandoned; and
step S45: the homogeneous hydrosol solution is obtained at the discharge port 110 of the processing pipeline 101.

Example 2: A preparation method of soft sweets (pectin) hydrosol solution is provided, compared to Example 1, the main difference lies in that the specific materials of each material property are different and the flow rates of various materials entering the processing pipeline 101 are inconsistent, while the other processes are the same, which will not be repeated here.

The total materials required for the soft sweets (gelatin) hydrosol solution are classified according to material properties as shown in Table 3:

TABLE 3
Classification table of total materials required
for the soft sweets (gelatin) hydrosol solution

| | Proportion | | Proportion |
|---|---|---|---|
| | in the total | | in the total |
| Mixture name | materials (%) | Material name | materials (%) |
| Solid phase | 36.530 | 220 Gelatin | 9.480 |
| materials | | powder | |
| | | White granulated | 27.050 |
| | | sugar powder | |
| Aqueous phase | 57.219 | Glucose syrup | 34.529 |
| materials | | Purified water | 22.690 |
| Oil phase | 0.874 | Lutein oil | 0.552 |
| functional | | Vitamin D oil | 0.322 |
| materials | | | |
| Aqueous phase | 2.034 | Ferric | 0.500 |
| functional | | pyrophosphate | |
| materials | | Sodium citrate | 0.143 |
| | | Glucose syrup | 1.143 |
| | | Purified water | 0.248 |
| Other | 3.343 | Jujube essence | 0.250 |
| ingredients | | Vegetable | 0.100 |
| | | carbon black | |
| | | Citric acid | 0.950 |
| | | Glucose syrup | 0.950 |
| | | Purified water | 1.093 |

The discharging flow rate of the discharge port 110 of the processing pipeline 101 is defined as Vₒᵤₜ, and Vₒᵤₜ is 200 kg/h.

The flow rate of various materials in the total materials required for the soft sweets (gelatin) hydrosol solution entering the processing pipeline 101 meets the following conditions as shown in Table 4 below.

TABLE 4
Flow rate of various materials in the total materials required
for the soft sweets (gelatin) hydrosol solution

| | Proportion | | |
|---|---|---|---|
| | in the total | Flow rate | |
| Mixture name | materials (%) | (kg/h) | Meeting conditions |
| Solid phase | 36.530 | 73.060 | V_{A} = 200 × 36.530% |
| materials | | | |
| Aqueous phase | 57.219 | 114.438 | V_{B} = 200 × 57.219% |
| materials | | | |
| Aqueous phase | 0.874 | 1.748 | V_{C} = 200 × 0.874% |
| functional | | | |
| materials | | | |
| Oil phase | 2.034 | 4.068 | V_{D} = 200 × 2.034% |
| functional | | | |
| materials | | | |
| Other | 3.343 | 6.686 | V_{E} = 200 × 3.343% |
| ingredients | | | |

Example 3: A preparation method of soft sweets (carrageenan) hydrosol solution is provided, compared to Example 1, the main difference lies in that the specific materials of each material property are different and the flow rates of various materials entering the processing pipeline 101 are inconsistent, while the other processes are the same, which will not be repeated here.

The total materials required for the soft sweets (carrageenan) hydrosol solution are classified according to material properties as shown in Table 5:

TABLE 5
Classification table of total materials required for
the soft sweets (carrageenan) hydrosol solution

| | Proportion | | Proportion |
|---|---|---|---|
| | in the total | | in the total |
| Mixture name | materials (%) | Material name | materials (%) |
| Solid phase | 33.620 | White granulated | 30.370 |
| materials | | sugar powder | |
| | | Carrageenan | 3.250 |
| Aqueous phase | 61.234 | Glucose syrup | 35.074 |
| materials | | Sodium citrate | 0.270 |
| | | Purified water | 25.890 |
| Oil phase | 0.993 | Vitamin E oil | 0.463 |
| functional | | Vitamin A oil | 0.530 |
| materials | | | |
| Aqueous phase | 1.153 | Vitamin C | 0.891 |
| functional | | Vitamin B1 | 0.262 |
| materials | | | |
| Other | 3.000 | Annatto | 0.280 |
| ingredients | | Sweet orange | 0.300 |
| | | essence | |
| | | Citric acid | 0.930 |
| | | Purified water | 1.490 |

The discharging flow rate of the discharge port 110 of the processing pipeline 101 is defined as Vₒᵤₜ, and Vₒᵤₜ is 200 kg/h.

The flow rate of various materials in the total materials required for the soft sweets (carrageenan) hydrosol solution entering the processing pipeline 101 meets the following conditions as shown in Table 6 below.

TABLE 6
Flow rate of various materials in the total materials required
for the soft sweets (carrageenan) hydrosol solution

| | Proportion | | |
|---|---|---|---|
| | in the total | Flow rate | |
| Mixture name | materials (%) | (kg/h) | Meeting conditions |
| Solid phase | 33.62 | 67.240 | V_{A} = 200 × 33.62% |
| materials | | | |
| Aqueous phase | 61.234 | 122.468 | V_{B} = 200 × 61.234% |
| materials | | | |
| Aqueous phase | 0.993 | 1.986 | V_{C} = 200 × 0.993% |
| functional | | | |
| materials | | | |
| Oil phase | 1.153 | 2.306 | V_{D} = 200 × 1.153% |
| functional | | | |
| materials | | | |
| Other | 3.000 | 6.000 | V_{E} = 200 × 3.000% |
| ingredients | | | |

Example 4: A preparation method of soft capsule rubber hydrosol solution is provided, compared to Example 1, the main difference lies in that the specific materials of each material property are different and the flow rates of various materials entering the processing pipeline 101 are inconsistent, while the other processes are the same, which will not be repeated here.

The total materials required for the soft capsule rubber hydrosol solution are classified according to material properties as shown in Table 7:

TABLE 7
Classification table of total materials required
for the soft capsule rubber hydrosol solution

| | Proportion | | Proportion |
|---|---|---|---|
| | in the total | | in the total |
| Mixture name | materials (%) | Material name | materials (%) |
| Solid phase | 45.0 | Gelatin | 45.0 |
| materials | | granules | |
| Aqueous phase | 50.0 | Glycerol | 18.0 |
| materials | | Pure water | 32.0 |
| Other | 5.0 | Caramel | 0.8 |
| ingredients | | color | |
| | | Water | 4.2 |

The discharging flow rate of the discharge port 110 of the processing pipeline 101 is defined as Vₒᵤₜ, and Vₒᵤₜ is 250 kg/h.

The flow rate of various materials in the total materials required for the soft capsule rubber hydrosol solution entering the processing pipeline 101 meets the following conditions as shown in Table 8 below.

TABLE 8
Flow rate of various materials in the total materials
required for the soft capsule rubber hydrosol solution

| | Proportion | | |
|---|---|---|---|
| | in the total | Flow rate | |
| Mixture name | materials (%) | (kg/h) | Meeting conditions |
| Solid phase | 45.0 | 112.5 | V_{A} = 250 × 45.0% |
| materials | | | |
| Aqueous phase | 50.0 | 125.0 | V_{B} = 250 × 50.0% |
| materials | | | |
| Other | 5.0 | 12.5 | V_{E} = 250 × 5.0% |
| ingredients | | | |

The present disclosure has the following beneficial effects:

1. The system and preparation method can be applied to the preparation process of hydrosol solution in daily chemicals, food and drugs, and can simultaneously introduce various functional ingredients and auxiliary materials online, especially, it has more advantages in the preparation of relatively viscous water-soluble systems such as gel jelly solution, soft capsule rubber solution, soft sweets syrup.

2. The process and system also have unique advantages in the aspect of heat-sensitive functional materials. The first feeding unit for storing the solid phase materials and the second feeding unit for storing the aqueous materials are connected to one side of the processing pipeline close to the drive motor, the materials entering the online material mixing and shearing device are fully dispersed, dissolved, and sheared, the third feeding units and fourth feeding units for storing the functional materials and the fifth feeding unit for storing other ingredients are connected near the outlet end of the processing pipeline, which reduces the time for heating, mixing and shearing of the functional materials, greatly improves the stability of functional ingredients, reduces the loss of nutrients, resulting in higher functional content and better quality of the obtained hydrosol solution.

3. Compared with the traditional hydrosol solution preparation process, this process changes the process of gradually adding, mixing, and boiling, uses a material mixing and shearing device and a quantitative feeding system to cascade the hydrosol solution preparation process, and digitally and automatically adjusts the discharging rate according to the proportion of materials in the formula, which simplifies the hydrosol solution preparation process, makes the data of the hydrosol solution preparation process clearer and the adjustment method more controllable, and saves time and labor costs. Compared with batch production, this process can achieve continuous production of hydrosol solution preparation, which lowers production costs, and improves labor efficiency.

4. The system and process are short in hydrosol solution preparation time. From the feeding of each material to the final hydrosol solution preparation, it only takes the time to pass through the online material mixing and shearing device, which reduces the time consumed by the entire process, and the preparation time of the hydrosol solution does not exceed 3 min, greatly improving production efficiency.

5. The workload of operators is reduced, the production process is simple, the continuity is high, the occupation of factory space is reduced, and the economic benefits are improved.

The above examples only express several embodiments of the present disclosure, their descriptions are relatively specific and detailed, but cannot be understood as limiting the patent scope of the present disclosure. It should be pointed out that for a person of ordinary skill in the art, several deformations and improvements can be made without departing from the concept of the present disclosure, all of which fall within the protection scope of the present disclosure. Therefore, the patent protection scope of the present disclosure should be based on the attached claims.

1. A preparation system of hydrosol solution, comprising a mixing and shearing device (100), a controller (200), and a plurality of feeding stations (300), wherein the plurality of feeding stations (300) are configured to store materials with different material properties, and all of the plurality of feeding stations (300) are connected with the mixing and shearing device (100) and transport the materials with different material properties to the mixing and shearing device (100), the controller (200) is electrically connected with the plurality of feeding stations (300) and controls material transportation speeds of the plurality of feeding stations (300), the controller (200) is electrically connected with the mixing and shearing device (100) and controls the operation of the mixing and shearing device (100), and the mixing and shearing device (100) is configured to simultaneously mix and shear the materials with different material properties to obtain the hydrosol solution.

2. The preparation system of hydrosol solution according to claim 1, wherein the mixing and shearing device (100) comprises a processing pipeline (101), a first screw (102), and a drive motor (103), the feeding stations (300) are in communication with the processing pipeline (101) to transport materials with different material properties into the processing pipeline (101), the first screw (102) is arranged inside the processing pipeline (101), the drive motor (103) is electrically connected with the controller (200) to drive the first screw (102) to simultaneously mix and shear all the materials in the processing pipeline (101) to obtain the hydrosol solution, and the first screw (102) discharges the obtained hydrosol solution from a discharge port (110) of the processing pipeline (101).

3. The preparation system of hydrosol solution according to claim 2, wherein the plurality of feeding stations (300) comprises a first feeding unit (1) for storing solid phase materials and a second feeding unit (2) for storing aqueous phase materials, and both the first feeding unit (1) and the second feeding unit (2) are in communication with the processing pipeline (101) through a pipeline (400).

4. The preparation system of hydrosol solution according to claim 3, wherein the plurality of feeding stations (300) further comprise a third feeding unit (3) for storing aqueous phase functional materials and a fourth feeding unit (4) for storing oil phase functional materials, and both the third feeding unit (3) and the fourth feeding unit (4) are in communication with the processing pipeline (101) through the pipeline (400).

5. The preparation system of hydrosol solution according to claim 4, wherein a first feeding port (111) and a second feeding port (112) are provided in one end of the processing pipeline (101) close to the drive motor (103), a third feeding port (113) and a fourth feeding port (114) are provided in one end of the processing pipeline (101) close to the discharge port (110), the first feeding unit (1) is connected to the first feeding port (111), the second feeding unit (2) is connected to the second feeding port (112), the third feeding unit (3) is connected to the third feeding port (113), and the fourth feeding unit (4) is connected to the fourth feeding port (114).

6. The preparation system of hydrosol solution according to claim 5, wherein the first feeding unit (1) comprises a hopper (10) for storing the solid phase materials, a second propulsion screw (11), a solid material pipeline (12), and a servo motor (13), one side of the solid material pipeline (12) is connected with the hopper (10), the other side is connected with the first feeding port (111) through the pipeline (400), the second propulsion screw (11) is arranged in the solid material pipeline (12), and the servo motor (13) is electrically connected with the controller (200) to drive the second propulsion screw (11) to push the solid materials and send them to the processing pipeline (101).

7. The preparation system of hydrosol solution according to claim 5, wherein the second feeding unit (2) comprises at least one second batching tank (20) for holding the aqueous phase materials and a second metering pump (21), the second batching tank (20) is connected to the second feeding port (112) through the pipeline (400), and the second metering pump (21) is arranged on the pipeline (400) to control a flow rate of the aqueous phase materials entering the processing pipeline (101).

8. The preparation system of hydrosol solution according to claim 5, wherein the third feeding unit (3) comprises at least one third batching tank (30) for holding the aqueous phase functional materials and a third metering pump (31), the third batching tank (30) is connected to the third feeding port (113) through the pipeline (400), and the third metering pump (31) is arranged on the pipeline (400) to control a flow rate of the aqueous phase functional materials entering the processing pipeline (101).

9. The preparation system of hydrosol solution according to claim 5, wherein the fourth feeding unit (4) comprises at least one fourth batching tank (40) for holding the oil phase functional materials and a fourth metering pump (41), the fourth batching tank (40) is connected to the fourth feeding port (114) through the pipeline (400), and the fourth metering pump (41) is arranged on the pipeline (400) to control a flow rate of the oil phase functional materials entering the processing pipeline (101).

10. The preparation system of hydrosol solution according to claim 5, wherein the first screw (102) comprises a plurality of sets of propulsion sections (121) and shearing sections (122), and the propulsion sections (121) and the shearing sections (122) are arranged at intervals from each other.

11. The preparation system of hydrosol solution according to claim 10, wherein the first feeding port (111), the second feeding port (112), the third feeding port (113), and the fourth feeding port (114) all correspond to positions of the propulsion sections (121) in the processing pipeline (101).

12. The preparation system of hydrosol solution according to claim 11, wherein the first feeding port (111) and the second feeding port (112) correspond to the same propulsion section (121) in the processing pipeline (101), and the third feeding port (113) and the fourth feeding port (114) correspond to the same propulsion section (121) in the processing pipeline (101).

13. The preparation system of hydrosol solution according to claim 12, wherein a portion of the first screw (102) located between the second feeding port (112) and the third feeding port (113) is provided with at least one set of shearing sections (122).

14. The preparation system of hydrosol solution according to claim 12, wherein a portion of the first screw (102) located between the third feeding port (113) and the discharge port (110) is provided with at least one set of shearing sections (122).

15. The preparation system of hydrosol solution according to claim 12, wherein the propulsion section (121) is composed of a plurality of sets of propulsion thread modules (123), the shearing section (122) is composed of a plurality of sets of shearing thread modules (124), a thread pitch d1 of the propulsion thread module (123) of the propulsion section (121) is 36-112 mm, and a thread pitch d2 of the shearing thread module (124) of the shearing section (122) is 22-96 mm.

16. The preparation system of hydrosol solution according to claim 12, wherein the plurality of feeding stations (300) further comprise a fifth feeding unit (5) for storing other ingredients, the fifth feeding unit (5) comprises at least one fifth batching tank (50) for holding the other ingredients and a fifth metering pump (51), the fifth batching tank (50) is connected to a fifth feeding port (115) in the processing pipeline (101) through the pipeline (400), the fifth feeding port (115) and the third feeding port (113) correspond to the same propulsion section (121) in the processing pipeline (101), and the fifth metering pump (51) is arranged on the pipeline (400) to control a flow rate of the other ingredients entering the processing pipeline (101).
